(19) United States
(12) Patent Application Publication
(10) Pub. No.: US 2008/0222530 A1
(43) Pub. Date: Sep. 11, 2008

(54) Navigating user interface controls on a two-dimensional canvas

(75) Inventors: Thyagarajan Lakshmanan, Redmond, WA (US); Ting-yi Yang, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,315

(22) Filed: Mar. 6, 2007

(51) Int. Cl. G06F 15/177; G06F 3/048

(52) U.S. Cl. 715/735; 715/764; 715/802; 715/856

(57) ABSTRACT

Described is a technology for two-dimensional navigation among user interface controls of a canvas based on up, down, left or right navigational commands received from a two-dimensional directional input mechanism such as a D-Pad, such as on a mobile device. Navigation includes iterating over candidate controls to determine which will control be chosen receive focus based on a received navigational command, the control that currently has focus, and criteria including distance and relative position of each candidate control to the control currently having focus. Vertical distance (alignment) as well as absolute distance may be used to determine the candidate control having the least computed distance. Direction and whether the candidate control is also currently visible in a viewport when the control having focus is currently visible in the viewport are other criteria that may be used in selecting a chosen control on which focus will be set.

### BACKGROUND

Navigating a two-dimensional canvas such as a web page can be easily done using a mouse or similar pointing device on a personal computer. For example, when a user wants to click on a user interface object on a web page, such as a hyperlink, the user simply positions the mouse pointer directly over the hyperlink and appropriately clicks the mouse. Notwithstanding, this seemingly simple task is hard to perform on a hand-held or mobile device, such as a Smartphone, because these devices do not have a mouse. Rather, the user generally has to use directional buttons for any user interface interaction. Indeed, this is a main reason why the navigation that is available on mobile devices is primarily one-dimensional. For example, most mobile web browsers offer only the ability for users to navigate up and down on a web page.

As mobile devices are becoming more powerful and popular, the applications that run on them are becoming more feature-intensive. In the future, it will be likely desirable to have the web browsing experience on a mobile device be very similar to the web browsing experience on a desktop or notebook, including two-dimensional navigation aspects. However, any such two-dimensional navigation on a mobile device will need to deal with the difficulties of a mobile device's button mechanism that is far more suitable for one-dimensional navigation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards two-dimensional navigation among user interface controls of a canvas by choosing a control to have focus based on a received navigational command, the control that currently has focus, and criteria including distance and relative position (e.g., alignment) of each candidate control to the control currently having focus.

In one example implementation, when the navigation command comprises an up or down command, the criteria is evaluated, including determining whether each control of a set of a candidate controls horizontally overlaps with the current control having focus, and if so, by computing a distance for that candidate control based on a vertical distance to the control in focus. If the candidate control does not horizontally overlap, the distance is computed as an absolute distance to the control in focus. The chosen control is the control having the least computed distance that is also above the control having focus for an up command or below the control having focus for a down command, and is also currently visible in a viewport when the control having focus is currently visible in the viewport.

In one example implementation, when the navigation command comprises a left or right command, a distance is computed for each candidate control based on a vertical upper boundary distance to the control in focus and an absolute distance to the control in focus. The vertical upper boundary distance may be given more weight in the computed distance than the absolute distance. The chosen control is selected as the control having the least computed distance that is also to the left of the control having focus for a left command, or to the right of the control having focus for a right command, and is also currently visible in a viewport when the control having focus is currently visible in the viewport.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a mobile device that is configured for two-dimensional navigation among objects of a canvas.

FIG. 2 shows an illustrative example canvas including user interface controls (objects) to which a user can navigate in two dimensions.

FIGS. 3-7 comprise a flow diagram representing example logic to handle two-dimensional user navigational input commands including up, down, left and right commands.

### DETAILED DESCRIPTION

Various aspects of the technology described herein are generally directed towards a technique for navigating a two-dimensional canvas such as a web page on a mobile device, using limited mobile device buttons, such as a four-directional button interface (of a D-Pad). In one example implementation, example logic/a mechanism is described that, whenever one of the four directional buttons is pressed on a mobile device, intelligently predicts which user interface object on a web page the focus is to be set. In other words, the logic determines where to set focus in response to detection of either a right, left, up or down button press.

While one example implementation described herein includes the example logic/mechanism in the form of an algorithm that provides a set of rules for determining on which object to focus in response to which button is pressed, it is understood that this is only one example. For example, a more complex algorithm can be used, such as one based on the algorithm described herein, and further enhanced with special exceptions to the general rules, such as determined from empirical testing. Further, the technology is not limited to a D-Pad interface, but rather contemplates any equivalent input mechanisms or combinations thereof; for example, sensors corresponding to left and right input navigation commands in conjunction with an up-and-down scroll wheel, or vice versa, would be an alternative multi-directional input mechanism.

As such, the present invention is not limited to any particular embodiments, aspects, concepts, protocols, structures, mechanisms, algorithms, functionalities or examples described herein. Rather, any of the embodiments, aspects, concepts, protocols, structures, mechanisms, algorithms, functionalities or examples described herein are non-limiting, and the present invention may be used various ways that provide benefits and advantages in computing and user interface navigation in general.

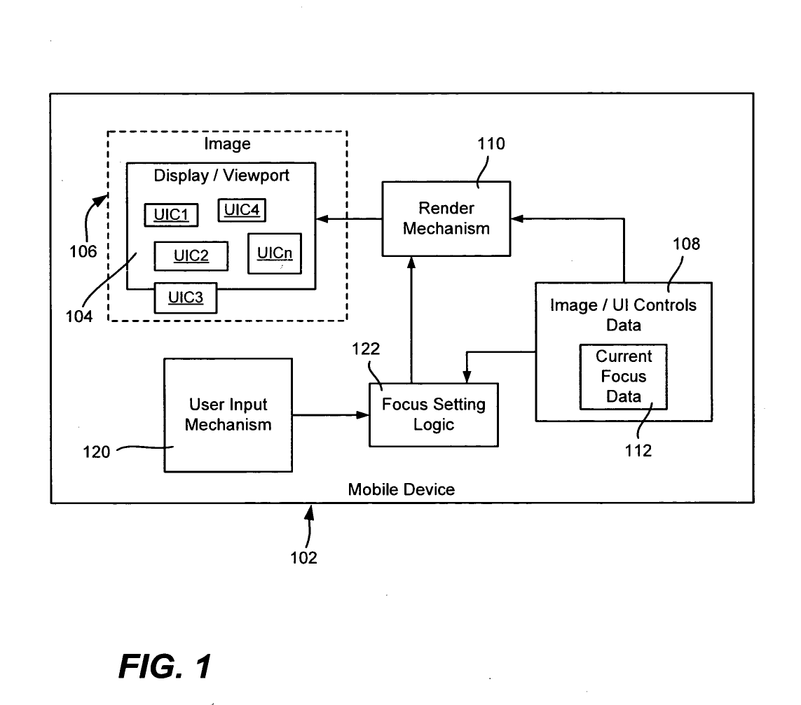

Turning to FIG. 1, there is shown a representation of a mobile device 102 on which a two-dimensional canvas can be rendered. To this end, the mobile device has a display screen 104 with various user interface (UI) controls (objects) UIC1-UICn of an example web page image 106 displayed thereon. As is typical with browsers, the image 106 and its controls correspond to data 108 that a render mechanism 110 processes for outputting to the display 104. One of the controls is currently in focus, as tracked by focus data 112, including a control having focus by default, e.g., whether initially specified by the author or selected by device logic as having the default focus.

Note that as represented in FIG. 1, the image 106 may be larger than the display screen 104, whereby scrolling is available to move the image 106 and its objects relative to the display area. Further note that as used herein, a “viewport” comprises a visual rectangular area over an image whose size is restrained by the device form factor. In other words, only the area within the viewport is currently displayed on the device. Although not shown in FIG. 1, the display area may be larger than the viewport, such as to provide a browser toolbar above or below the portion of the image displayed in the viewport. For purposes of this description, the viewport/display screen 104 are logically considered the same (e.g., in size and shape).

As represented in FIG. 1, the controls UIC1-UICn each comprise a rectangular object as part of the image 106. Each control can be described by a coordinate set of left, right, top and bottom properties. The left and right properties represent its horizontal position, where left is always less than right. The top and bottom properties represent its vertical position where in this system (as in typical display systems) top is always less than bottom.

The control in focus is the UI control that is currently highlighted or otherwise marked as such, such as by a rectangular border. In normal operation, at any given time only one control may be in focus. As described below, image navigation begins with the control in focus; a default control may be specified by the content designer or selected by a device mechanism, e.g., when no control is focus, the control that is closest to the center of the viewport is chosen as the default control in focus in the following example description. Note that any suitable alternative may be used for selecting a default control, e.g., the uppermost/leftmost control that is visible may be the default focused control.

In FIG. 1, the user moves focus (and also may make selections and so forth) via interaction with a user input mechanism 120. As is understood, in two-dimensional, four direction navigation, a user may select to go up, go right, go left, or go down. Go up is generally the action to switch the control in focus from the current one to another one that is visually above the current control in focus. Go right is the action to switch the control in focus from the current one to another one that is visually to the right of the current control in focus. Go left is the action to switch the control in focus from the current one to another one that is visually to the left of the current control in focus. Go down is the action to switch the control in focus from the current one to another one that is visually below the current control in focus.

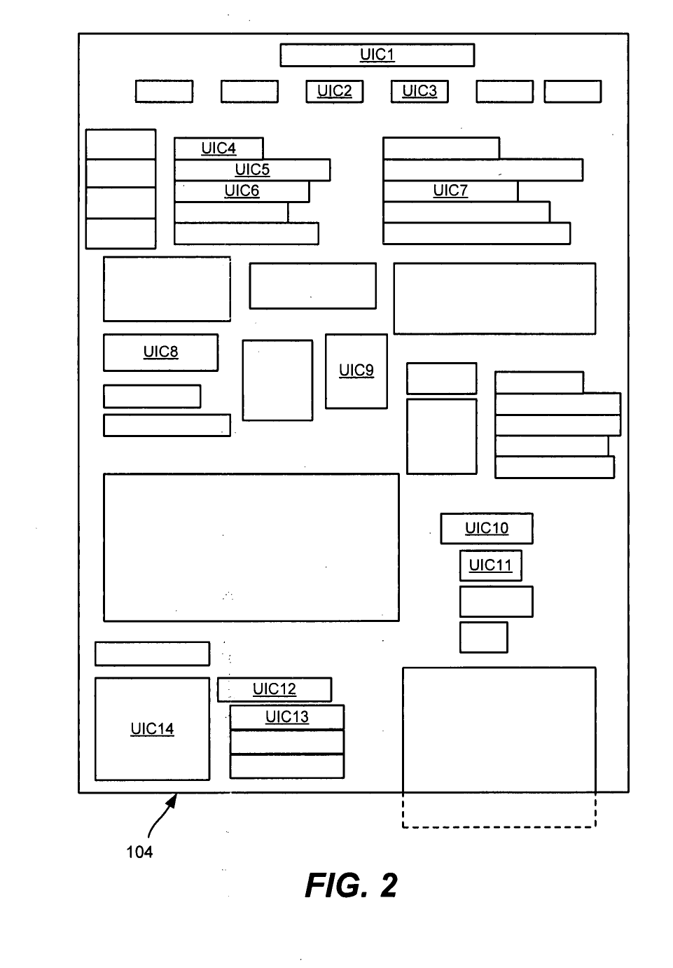

As can be readily appreciated, various considerations are needed to be handled to perform two-dimensional navigation that meets with users' general expectations. For example, in FIG. 2 which shows example content visible in the viewport 104, consider a user at the control labeled UIC7 that wants to move focus left. Note that in FIG. 2, each rectangular block represents a control (although the only controls used in the examples herein are labeled with an identifier). Further, other data that cannot receive focus, such as text and images, may be visible in the viewport 104, such as in the blank areas in FIG. 2 between the controls.

Returning to the example of focus currently at the control UIC7 and moving left, a visual inspection of the controls' relative positions indicates that a typical user would most likely expect to navigate focus to the control UIC6 in response to a left user action when focus is at the control UIC7. However, the control UIC6 is not the closest control in absolute distance to the control UIC7; rather UIC5 is the closest control. Thus, example focus setting logic 122 (FIG. 1) is provided herein to better match user expectations with respect to navigation.

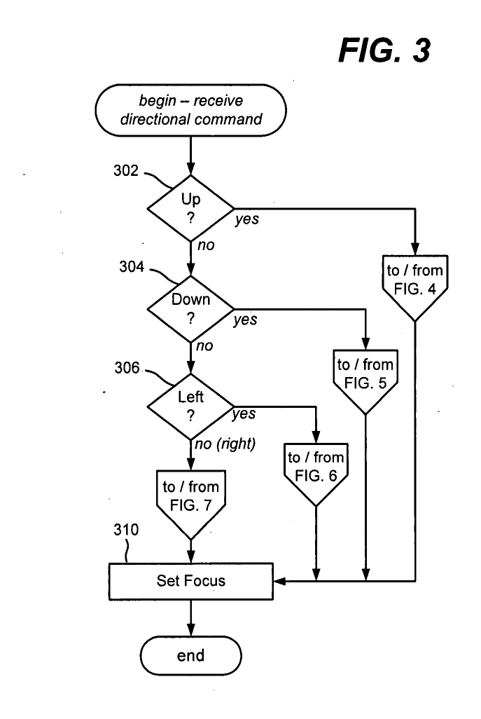

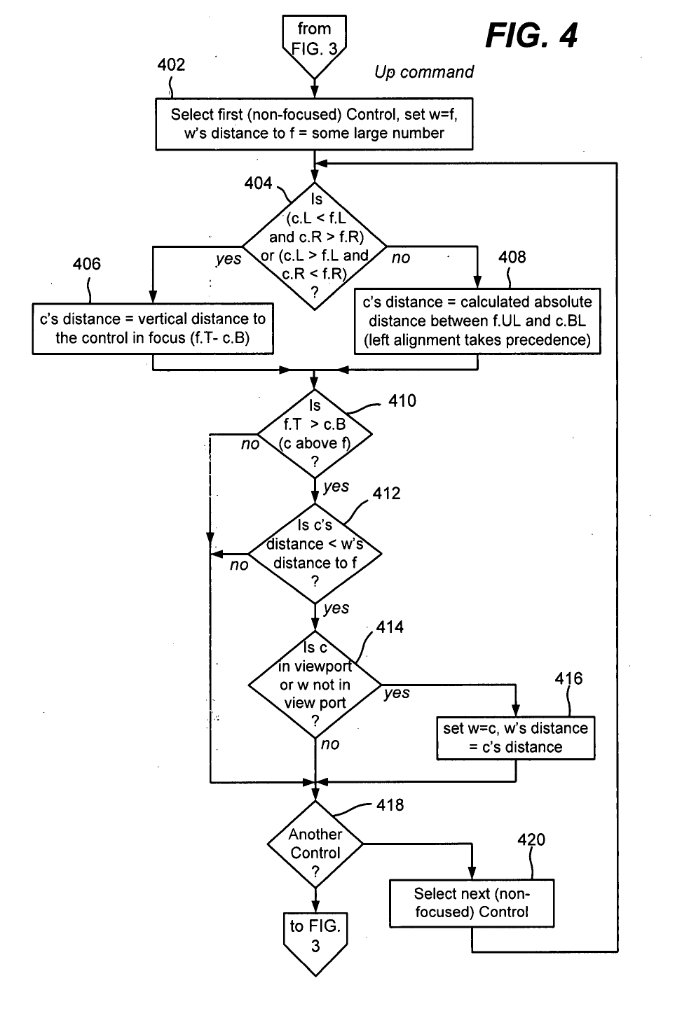

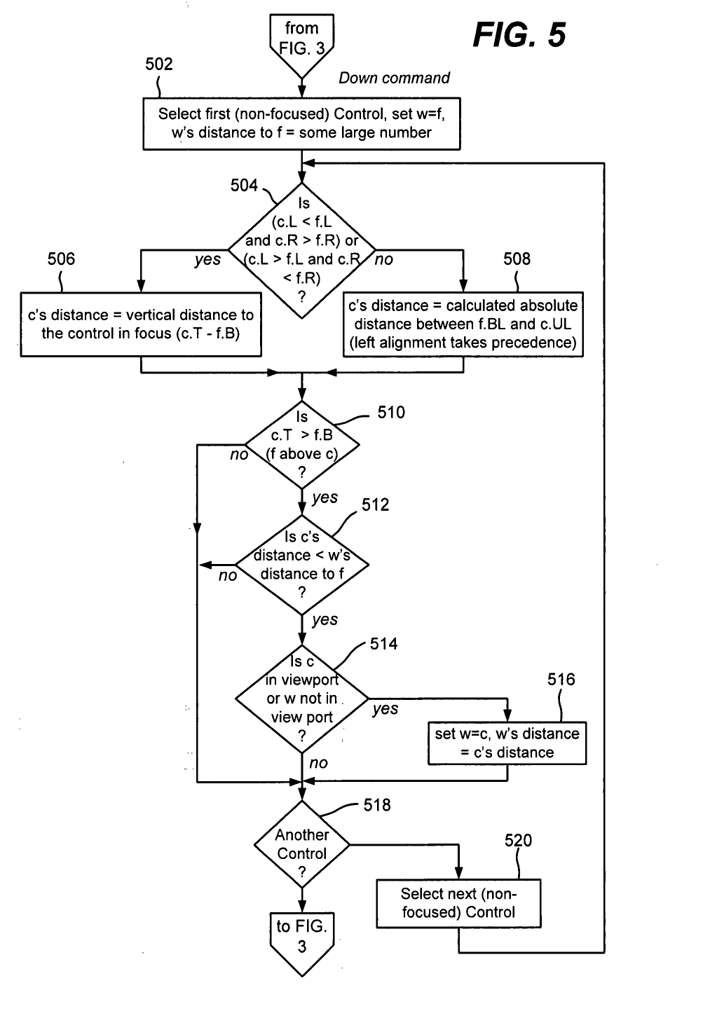

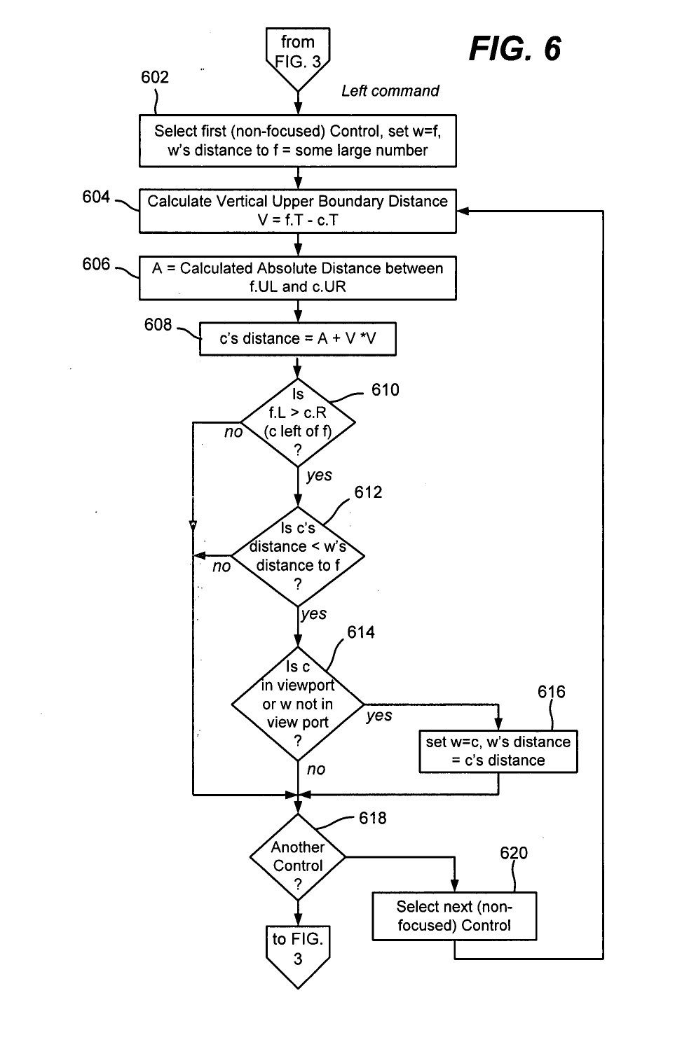

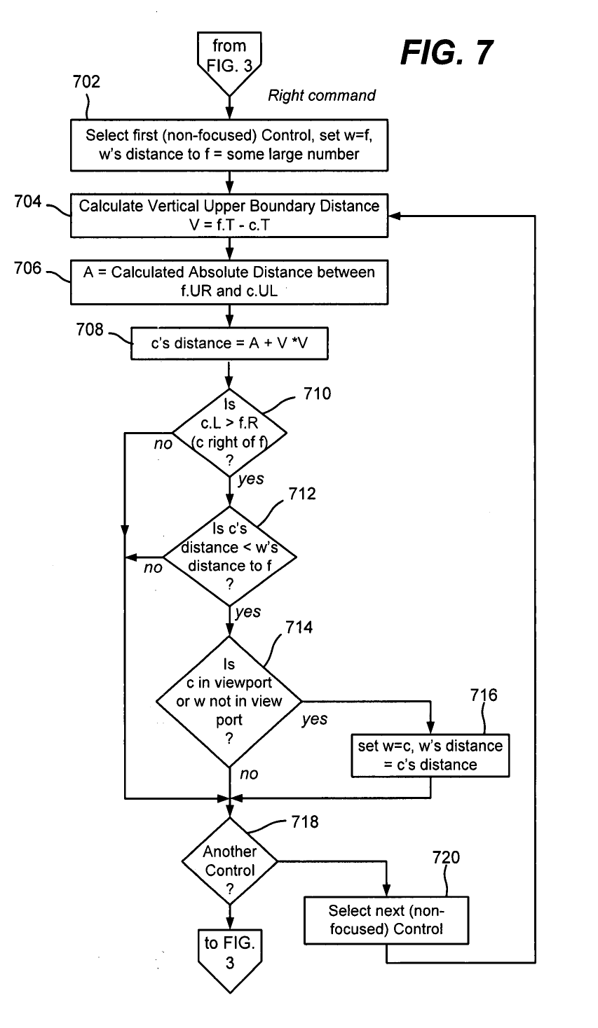

FIGS. 3-7 provide a description of the focus setting logic 122.with respect to receiving an up (FIG. 4), down (FIG. 5), left (FIG. 6) or right (FIG. 7) user input directional action, that is, a navigation command. Note that in the following description, controls are represented by lower case letters and properties by upper case letters properties, demarcated with a dot, e.g., “c.L” means control c's left boundary. Thus, “L” (without the quotes) represents a control's left boundary, “R” a control's right boundary, “U” its upper boundary, and “B” its bottom boundary. Further, “UL” represents a control's upper left corner, “UR” its upper right corner, “BL” its bottom left corner, and “BR” its bottom right corner, (again without the quotes in this example description). Also, “X” represents a point's x-position, and “Y” its y-position. For example, absolute distance is used to measure the distance of two points p1 and p2 in a two-dimensional space by the Pythagorean theorem:

Distance=Square root of ((p1.X−p2.X)*(p1.X−p2.X)+(p1.Y−p2.Y)*(p1.Y−p2.Y)

In general, the focus setting logic 122 decides which UI control is to be in focus based on the current control in focus and a user navigation action. In the event that no control is focus, in this example implementation, the control that is closest to the center of the viewport is chosen as the default control in focus.

Turning to FIG. 3, when a user navigational command is received, steps 302, 304 and 306 represent triggering the appropriate handling of the command by the various direction-based focus setting logic 122 that determines the new focus. Upon return, step 310 represents setting the focus to the control identified by the corresponding logic 122.

For example, when a “go up” command is detected at step 302, the example steps of FIG. 4 are executed, in which the distance from each control to the control in focus f is measured, with the current closest/most appropriate control set to w. Initially, w is set to the control in focus or some other value such as NULL so that focus will only change if certain conditions are met; further, w's distance to f is initialized to some high number so that a closer control (if appropriate) can be located as the process iterates.

To this end, for a given control c (selected as represented via step 402) if at step 404 (c.L (c's left boundary) is less than f.L (f's left boundary), and c.R is greater than f.R) or (c.L is greater than f.L, and c.R is less than f.R), step 406 is executed. Note that “less than” and “greater than” can be replaced with “less than or equal” and “greater than or equal” in these computations, respectively, and indeed, some threshold closeness may be considered so that slightly imperfect alignment, position and/or distance can be considered acceptable. For example, if the left boundaries of two controls are within some allowable number of (e.g., one or two) x-values of one another, by including in the computations a slight offset adjustment, the two controls may be considered left-aligned for purposes of focus selection, even though the two are not exactly left-aligned.

Step 406 calculates the vertical distance to the control in focus by subtracting the f.T y-value (f's top boundary y-value) from the c.B (c's bottom boundary y-value) y-value. This means the new control, c, is horizontally overlapping with the control in focus, f. For example in FIG. 2, if the UC11 control was the control in focus, the UIC10 control would have such a relationship. Alternatively, if the UC10 control was the control in focus, the UC11 control also would have such relationship.

Otherwise, step 404 branches to step 408 to calculate the absolute distance between f.UL and c.BL, meaning left alignment takes precedence. For example, in FIG. 2, if the UIC5 control was the control in focus, the UIC4 control would have such a relationship.

At this time in the example logic, a determination is made as to whether the currently selected control c will change the w control, that is, the control to which focus will change, unless a better control is found during subsequent iterations. To this end, w is replaced by c if and only if the criteria set forth in steps 408, 410 and 412 are met.

More particularly, step 410 evaluates whether c is above f, that is, whether f.T is greater than c.B. If not, another control is selected as the next candidate control c via steps 418 and 420, until none remain, at which time whatever control (if any) that was found to be the best w is the control to which focus will be changed.

If c is above f as evaluated at step 410, c's distance as calculated at step 406 or 408 is compared to w's distance to f. This may be the large w's distance as initialized, in which event c's distance will be shorter, or a comparison against an actual distance set during a previous iteration. If c's distance is less than the current w's distance, the criteria at step 414 is next evaluated, otherwise this c is discarded and a new c selected via steps 418 and 420 (until no other candidate controls remain to evaluate) as described above.

Step 414 evaluates whether c and w are both in the viewport 104 (FIG. 1), or whether c and w are both not in the viewport 104, or whether c is in the viewport 104 and w is not. The result of this evaluation is that if w is in the viewport and c is not, w will not be replaced by c. This is generally based on the assumption that the user naturally wants to select something to receive focus that is currently visible, rather than change focus to a control that is not currently visible, (even though closer in the selected direction as determined via step 414).

In the event that the criteria of steps 410, 412 and 414 are met, at step 416 the candidate control w is replaced with the current control under evaluation c. The distance from w to f is also changed to the distance from c to f as measured at step 406 or 408, for future iteration distance comparisons at step 412. Steps 418 and 420 repeat the process for another control c until all have been evaluated, as described above.

When the iterations over each of the non-focused controls is complete, w is known and is chosen as the control to which focus is to be set. Note that it is possible that no control satisfied the criteria, e.g., nothing was above f when the user pressed up, whereby focus need not change from f. Step 418 returns to FIG. 3 when all candidate controls have been evaluated, and focus set (if needed) to the chosen control corresponding to the w control, as represented by step 310.

When a down command is received, step 304 executes the logic represented in FIG. 5. Note that the steps of FIG. 5 are substantially similar to those of FIG. 4, with the evaluated above or below directions generally reversed, and thus the various steps of FIG. 5 will not be described again except to emphasize the differences from FIG. 4.

For example, when the candidate control c under evaluation is horizontally overlapping the control with focus f, the vertical distance at step 506 measures c's top y-value to the f's bottom y-value. This is represented in FIG. 2 via the relationship between the controls UIC5 (f) and UIC6 (c).

Further, as part of the criteria for replacing w with c, step 510 evaluates whether f is above c, since the requested direction is down. Otherwise the replacement criteria is the same as in FIG. 4, namely distance-based evaluation (step 512) and viewport considerations (step 514). As can be understood by following the logic of FIG. 5, whatever candidate control (if any) below the focused control f that best meets the criteria including the distance evaluation becomes the control to which focus is changed. Left alignment is thus a factor in the determination.

Turning to a consideration of horizontal navigation, FIG. 6 represents a go left command, and FIG. 7 represents a go right command. Step 306 of FIG. 3 represents branching to the appropriate left and right handling logic to determine where to set focus.

Step 602 of FIG. 6 represents initializing w and w's distance to f, as generally described above, and selecting a first candidate control as the control to evaluate, c. Step 604 calculates the vertical upper boundary distance V between c and f by subtracting f.T by c.T. The upper boundaries are used because when moving horizontally, the user naturally want to choose a control at the same horizontal level. This is exemplified in FIG. 2 by the relationship between the control UIC9 (f) and the control UIC8 (c).

Step 606 calculates the absolute distance A between f.UL and c.UR. At step 608, the total distance for c is then set to A+V*V in this example implementation. This formula ensures that the vertical distance takes precedence over the absolute distance, while at the same time taking the absolute distance into consideration. For example, when going left from the control UIC7 in FIG. 1, the control UIC6 will be considered a better choice instead of the control UIC5, although the UIC5 control is closer in absolute distance.

At this time in the example, a determination is made as to whether the current candidate control c will change the w control, that is, the control to which focus will change unless a better control is found during subsequent iterations. To this end, w is replaced by c if and only if the criteria set forth in steps 610, 613 and 614 are met.

More particularly, step 610 evaluates whether c is to the left of f, that is, whether f.L is greater than c.R. If not, another control is selected as the next candidate control c via steps 618 and 620 until none remain, at which time whatever control (if any) found to be the best w is the control to which focus will be changed.

If c is to the left of f, c's distance as computed at step 608 is compared to w's distance to f. This may be the large w's distance as initialized, in which event c's distance will be shorter, or a comparison against an actual distance set during a previous iteration. If c's distance is less than the current w's distance, the criteria at step 614 is next evaluated, otherwise this candidate c is discarded and a new candidate c selected via steps 618 and 620 (until none remain) as described above.

Step 614 evaluates whether c (the current candidate) and w (the best candidate found thus far) are both in the viewport 104 (FIG. 1), or whether c and w are both not in the viewport 104, or whether c is in the viewport 104 and w is not. The result of this evaluation is that if w is in the viewport and c is not, w will not be replaced by c, on the assumption that the user naturally wants to select something that is currently visible, rather than a control (although closer in the direction as determined via step 614) that is not currently visible.

In the event that the criteria of steps 610, 612 and 614 are met, at step 616 the control w is replaced with the current candidate control under evaluation c. The distance from w to f is also changed to the distance from c to f as computed at step 608, for future iteration distance comparisons at step 612. Steps 618 and 620 repeat the process for another candidate control c until all have been evaluated, as described above.

When the iterations over each of the non-focused controls is complete, w is known. It is possible that no control satisfied the criteria, e.g., nothing was left of the control f when the user pressed left, whereby f need not change. Step 618 returns to FIG. 3 when all have been evaluated, and focus set (if needed) to the control corresponding to the w control, as represented by step 310.

FIG. 7 represents handling a go right command. As with the relationship between FIGS. 4 and 5, the logic of FIG. 7 is very similar to that of FIG. 6, and thus is not again described except to point out left versus right differences. Note, for example, that the upper boundaries are similarly used because user naturally wants to choose a control at the same horizontal level, e.g., to go from the control UIC14 to the control UIC12 rather than the control UIC13 when the right button is pressed. Similarly, the vertical distance takes precedence over the absolute distance while still considering the absolute distance, so that, for example, when going right from the control UIC2, the control UIC3 will be chosen as the next focus rather than the control UIC1 although the control UIC1 is closer in absolute distance.

Again, when iterating through each selected control c, w is replaced by the current candidate c if and only if the criteria of steps 710, 712 and 714 are met. Note that since attempting to move focus to the right, step 710 considers whether c is to the right of f, rather than vice-versa as in FIG. 6. Otherwise the replacement criteria of FIG. 7 are the same as in FIG. 6, namely distance-based evaluation (step 712) and viewport considerations (step 714). As can be understood by following the logic of FIG. 7, whatever (if any) control to the right of the focused control f that best meets the criteria including the distance computation becomes the control to which focus is changed.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
receiving an up, down, left or right navigation command with respect to a set of controls rendered on a canvas, the controls including a current control having focus;
determining a chosen control to set as having focus by evaluating criteria, including distance and relative position criteria, between the current control having focus and each control of a set of a candidate controls; and
setting focus to the chosen control.

2. The computer-readable medium of claim 1 wherein receiving the navigation command comprises the navigation command via a directional pad of a mobile device.

3. The computer-readable medium of claim 1 wherein the set of a candidate controls comprise all controls corresponding to the canvas other than the current control having focus, and wherein determining the chosen control comprises iterating over all of the candidate controls.

4. The computer-readable medium of claim 1 wherein the navigation command comprises an up or down command, and wherein evaluating the criteria includes determining whether each control of a set of a candidate controls horizontally overlaps with the current control having focus.

5. The computer-readable medium of claim 4 wherein when a candidate control horizontally overlaps with the current control having focus, evaluating the criteria further comprises computing a distance for that candidate control based on a vertical distance to the control in focus.

6. The computer-readable medium of claim 4 wherein when a candidate control does not horizontally overlap with the current control having focus, evaluating the criteria further comprises computing a distance for that candidate control based on an absolute distance to the control in focus.

7. The computer-readable medium of claim 6 wherein computing the distance comprises selecting as a first point the upper left coordinate set of the current control having focus and selecting as a second point the bottom left coordinate set of the candidate control.

8. The computer-readable medium of claim 1 wherein the navigation command comprises an up or down command, and wherein evaluating the criteria includes determining whether each control of a set of a candidate controls horizontally overlaps with the current control having focus, and
a) when a candidate control horizontally overlaps with the current control having focus, evaluating the criteria further comprises computing a distance for that candidate control based on a vertical distance to the control in focus, or
b) when a candidate control does not horizontally overlap with the current control having focus, evaluating the criteria further comprises computing a distance for-that candidate control based on an absolute distance to the control in focus, including selecting as a first point the upper left coordinate set of the current control having focus and selecting as a second point the bottom left coordinate set of the candidate control; and
selecting as the chosen control the control having the least computed distance that is also above the control having focus for an up command or below the control having focus for a down command, and is also currently visible in a viewport when the control having focus is currently visible in the viewport.

9. The computer-readable medium of claim 1 wherein the navigation command comprises a left or right command, and wherein evaluating the criteria includes computing a computed distance for each candidate control based on a vertical upper boundary distance to the control in focus and an absolute distance to the control in focus.

10. The computer-readable medium of claim 9 wherein for each candidate control, the vertical upper boundary distance is given more weight in the computed distance than the absolute distance.

11. The computer-readable medium of claim 9 wherein determining the chosen control comprises selecting as the chosen control the control having the least computed distance that is also to the left of the control having focus for a left command or to the right of the control having focus for a right command, and is also currently visible in a viewport when the control having focus is currently visible in the viewport.

12. In a computing device having a user input mechanism that provides up, down, left and right navigational commands, a system comprising:
canvas display means, including means for rendering user interface controls corresponding to data of the canvas in a viewport, including one user interface control that currently has focus; and
focus setting logic coupled to the user input mechanism and the canvas display means, the focus setting logic configured to select a chosen user interface control to have focus based on the user interface control that currently has focus and a received navigational command, including by iterating over each control of a set of candidate controls to compute a distance value for each candidate control relative to the user interface control that currently has focus, and selecting as the chosen control based on criteria including the distance value.

13. The system of claim 12 wherein the navigational command is an up or down command, and wherein the focus setting logic computes the distance value for each candidate control by determining whether that candidate control horizontally overlaps with the control currently having focus and if so, by measuring a vertical distance from the candidate control to the control currently having focus, or if not, by measuring an absolute distance from the candidate control to the control currently having focus.

14. The system of claim 13 wherein the chosen control the control has the least computed distance that is also above the control saving focus for an up command or below the control having focus for a down command, and is also currently visible in the viewport when the control having focus is currently visible in the viewport.

15. The system of claim 12 wherein the navigation command comprises a left or right command, and wherein the focus setting logic computes the distance value for each candidate control by determining a vertical upper boundary distance to the control in focus and an absolute distance to the control in focus.

16. The system of claim 15 wherein for each candidate control, the vertical upper boundary distance is given more weight in the computed distance than the absolute distance.

17. The system of claim 15 wherein the chosen control the control has the least computed distance that is also to the left of the control having focus for a left command or to the right of the control having focus for a right command, and is also currently visible in the viewport when the control having focus is currently visible in the viewport.

18. In a computing device having a user input mechanism that provides up, down, left and right navigational commands, a method comprising:
receiving a navigation command when a user interface control of a canvas currently has focus, the canvas including a plurality of user interface controls;
iterating over each control of a set of candidate controls as a current candidate, and evaluating property data of that control against property data of the control currently having focus to determine whether the candidate control meets criteria for switching focus thereto, including determining a distance value for each candidate control relative to the control currently having focus and selecting as a chosen control to switch focus thereto a candidate control that has a lesser distance than any other control in a direction of the navigation command, the distance value for each candidate control including vertical alignment data relative to the control currently having focus for a left or right navigation command.

19. The method of claim 18 wherein the navigation command comprises an up or down command, and wherein evaluating the property data includes determining whether each control of the set of a candidate controls horizontally overlaps with the current control having focus, and
a) when a candidate control horizontally overlaps with the current control having focus, determining the distance value further comprises computing a distance for that candidate control based on a vertical distance to the control in focus, or
b) when a candidate control does not horizontally overlap with the current control having focus, determining the distance value further comprise computing a distance for that candidate control based on an absolute distance to the control in focus; and
selecting as the chosen control the control having the least computed distance that is also above the control having focus for an up command or below the control having focus for a down command, and is also currently visible in a viewport when the control having focus is currently visible in the viewport.

20. The method of claim 18 wherein the navigation command comprises a left or right command, and wherein evaluating the property data includes computing a computed distance for each candidate control based on a vertical upper boundary distance to the control in focus and an absolute distance to the control in focus, in which the vertical upper boundary distance is given more weight in the computed distance than the absolute distance, and wherein determining the chosen control comprises selecting as the chosen control the control having the least computed distance that is also to the left of the control having focus for a left command or to the right of the control having focus for a right command, and is also currently visible in a viewport when the control having focus is currently visible in the viewport.
